(19) United States
(12) Patent Application Publication
(10) Pub. No.: US 2008/0309665 A1
(43) Pub. Date: Dec. 18, 2008

(54) Distributed rapid prototyping

(75) Inventors: Richard O. Gregory, II, Rock Hill, SC (US); Daniel L. Perry, Charlotte, NC (US)

Correspondence Address: 3D Systems, Inc.;Attn: Keith A. Roberson, 333 Three D Systems Circle, Rock Hill, SC, 29730, US

(73) Assignee: 3D Systems, Inc., a California Corporation

(21) Appl. No.: 11/818,521

(22) Filed: Jun. 13, 2007

(51) Int. Cl. G06T 17/00

(52) U.S. Cl. 345/420

(57) ABSTRACT

A three-dimensional modeler for rapid prototyping three-dimensional modeler is registered with a global server in a network. The three-dimensional modeler receives, via a network interface, a build including information for use in generating a physical representation of a three-dimensional model. A queuing mechanism is used to determine the order in which builds are processed by a three-dimensional modeler. Processing of the build includes instructing hardware of the three-dimensional modeler to create the physical representation of the three-dimensional model. The network interface of the three-dimensional modeler may include a web server. The network interface may also be used to send diagnostics and receive feedback such as calibration data based on the diagnostics. The network interface may also be used to receive software code or data upgrades. The network interface may also be used to order supplies for the three-dimensional modeler.

### FIELD OF THE INVENTION

The present invention relates to the field of computer science. More particularly, the present invention relates to distributed rapid prototyping.

### BACKGROUND OF THE INVENTION

Typical solutions for RP (rapid prototyping) systems having modelers that produce three-dimensional models require that modeler software upgrades be manually performed by a user of the modeler. Additionally, modeler status and build status are typically available only at a computer attached to the modeler. The modeler software is typically compatible with only PC-based computers; UNIX and Apple OS-based systems are typically not supported by RP systems. Typical RP systems also require software drivers customized for a specific operating system. The user of the modeler must manually install a new version of a software driver when the operating system version changes. Accordingly, a need exists for an improved solution for using RP systems.

### SUMMARY OF THE INVENTION

A three-dimensional modeler for rapid prototyping three-dimensional object is registered with a global server in a network. The three-dimensional modeler receives, via a network interface, a build including information for use in generating a physical representation of a three-dimensional model. A queuing mechanism is used to determine the order in which builds are processed by a three-dimensional modeler. Processing of the build includes instructing hardware of the three-dimensional modeler to create the physical representation of the three-dimensional model. The network interface of the three-dimensional modeler may include a web server. The network interface may also be used to send diagnostics and receive feedback such as calibration data based on the diagnostics. The network interface may also be used to receive software code or data upgrades. The network interface may also be used to order supplies for the three-dimensional modeler.

According to one aspect, a three-dimensional modeler is connected to a network via a web server integrated with the three-dimensional modeler. The three-dimensional modeler is registered with a global server in the network, where the registering is based at least in part on an identifier describing the three-dimensional modeler. The three-dimensional modeler is activated upon successful completion of the registration.

According to another aspect, a command to create a build is received from a user. The build comprises build data information for use in generating a physical representation of a three-dimensional model. The build data information is created and submitted to a three-dimensional modeler in a network, using a web server integrated with the three-dimensional modeler.

According to another aspect, a three-dimensional modeler is connected to a network via a web server integrated with the three-dimensional modeler. Build information is received via the web server. The build is placed in a queue comprising one or more builds awaiting processing. Hardware of the modeler is then instructed to create the physical representation.

According to another aspect, diagnostics of a three-dimensional modeler are received from a global server configured to establish a session between the global server and the modeler. The modeler is coupled to a network via a first firewall, and the global server is coupled to the network via a second firewall. The three-dimensional modeler is for generating a physical representation of a three-dimensional model. The diagnostics comprise information about a build, which comprises information for use in generating the physical representation of the three-dimensional model. The diagnostics are analyzed. Feedback based at least in part on the analysis is sent via the global server.

According to another aspect, diagnostics are received from a three-dimensional modeler via a network interface. The three-dimensional modeler is for generating a physical representation of a three-dimensional model. The diagnostics comprise information about a build, which comprises information for use in generating the physical representation of the three-dimensional model. The diagnostics are analyzed. Feedback based at least in part on the analysis is sent via the network interface.

According to other aspects of the present invention, corresponding apparatus for carrying out the methods described above are provided.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram that illustrates a system for rapid prototyping in accordance with one embodiment of the present invention.

FIG. 3 is a block diagram that illustrates a system for rapid prototyping in accordance with one embodiment of the present invention.

FIG. 4 is a block diagram that illustrates a system for rapid prototyping in accordance with one embodiment of the present invention.

FIG. 5 is a block diagram that illustrates a system for rapid prototyping in accordance with one embodiment of the present invention.

FIG. 6 is a block diagram that illustrates a system for rapid prototyping in accordance with one embodiment of the present invention.

FIG. 7 is a block diagram that illustrates a system for rapid prototyping in accordance with one embodiment of the present invention.

FIG. 8 is a block diagram that illustrates a client computer for rapid prototyping in accordance with one embodiment of the present invention.

FIG. 9 is a block diagram that illustrates a method for modeler installation for rapid prototyping in accordance with one embodiment of the present invention.

FIG. 10 is a flow diagram that illustrates a high-level method for rapid prototyping from the perspective of a client computer in accordance with one embodiment of the present invention.

FIG. 11 is a flow diagram that illustrates a low-level method for rapid prototyping from the perspective of a client computer in accordance with one embodiment of the present invention.

FIG. 12 is a block diagram that illustrates a modeler for rapid prototyping in accordance with one embodiment of the present invention.

FIG. 13 is a flow diagram that illustrates a method for rapid prototyping from the perspective of a modeler in accordance with one embodiment of the present invention.

FIG. 14 is a block diagram that illustrates a local server for rapid prototyping in accordance with one embodiment of the present invention.

FIG. 15 is a block diagram that illustrates a global server for rapid prototyping in accordance with one embodiment of the present invention.

FIG. 16A is a flow diagram that illustrates a method for rapid prototyping from the perspective of a global server in accordance with one embodiment of the present invention.

FIG. 16B is a flow diagram that illustrates a method for rapid prototyping from the perspective of a global server in accordance with one embodiment of the present invention.

FIG. 16C is a flow diagram that illustrates a method for rapid prototyping from the perspective of a global server in accordance with one embodiment of the present invention.

FIG. 17 is a block diagram that illustrates a system for rapid prototyping in accordance with one embodiment of the present invention.

### DETAILED DESCRIPTION

Embodiments of the present invention are described herein in the context of distributed rapid prototyping. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “network” includes local area networks (LANs), wide area networks (WANs), metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “distributed” describes a digital information system dispersed over multiple computers and not centralized at a single location.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

In the context of the present invention, the term “network interface” describes the means by which users access a network for the purposes of communicating across it or retrieving information from it.

In the context of the present invention, the term “upgrade” describes an improved version of existing software code or data. The improved version may provide new or different functionality with respect to a previous version of existing software code or data. Alternatively or in addition thereto, the improved version may fix one or more bugs or problems with the previous version.

In the context of the present invention, the term “user interface” describes any device or group of devices for presenting and/or receiving information and/or directions to and/or from persons. A user interface may comprise a means to present information to persons, such as a visual display projector or screen, a loudspeaker, a light or system of lights, a printer, a Braille device, a vibrating device, or the like. A user interface may also include a means to receive information or directions from persons, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “web server” describes a computer system that stores and/or serves Web pages and/or data ready for access by other computers.

In the context of the present invention, the term “global server” describes a computer system that stores data and software ready for access by Web servers and other computers, and which can be located at one or more locations outside a customer's network.

In the context of the present invention the term “rapid prototyping” means any additive-type prototyping or manufacturing process, system or technology that produces one or more three-dimensional solid objects in a relatively rapid time period. This includes additive-type solid imaging techniques such as stereolithography, laminated object manufacturing (LOM), laser sintering, fused deposition modeling (FDM), flexible transport solid imaging (FTSI) (also called film transfer imaging (FTI)), various ink-jet based modeling systems or various digital light projection (DLP) based modeling systems. Such solid imaging techniques may include employing liquid resin formulations, plastic powder material, metal powder material or ink compositions that either solidify or fuse by temperature change or photocuring. Making either one or few prototype articles or multiple manufactured products are to be included with the scope of rapid prototyping and manufacturing as used herein. One solid imaging technique that may be used herewith is a FTSI technique disclosed in pending U.S. Provisional Patent Application Ser. No. 60/885,257, filed on Jan. 17, 2007, whose disclosure is hereby incorporated by reference in its entirety.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

In the context of the present invention, the term “build” describes information for use in generating a physical representation of a three-dimensional model, as well as the actual three-dimensional model being made.

Example embodiments of the present invention comprise an embedded web server in a rapid prototyping modeler configured to produce three-dimensional models. The embedded web server is configured to manage communication between the modeler and the network browsers of client computers. The modeler is also configured to manage real-time modeler operations, including managing slicing and support generation operations, and a build queue for managing jobs submitted to the modeler. By utilizing a web server resident in the modeler, a user can interact with the modeler independent of the operating system used by the user's client computer; the user need not manually upgrade modeler software drivers whenever the operating system version changes. Example embodiments of the present invention also allow remote submission of jobs. Example embodiments of the present invention also enable data mining of modelers for use in business applications and product improvements.

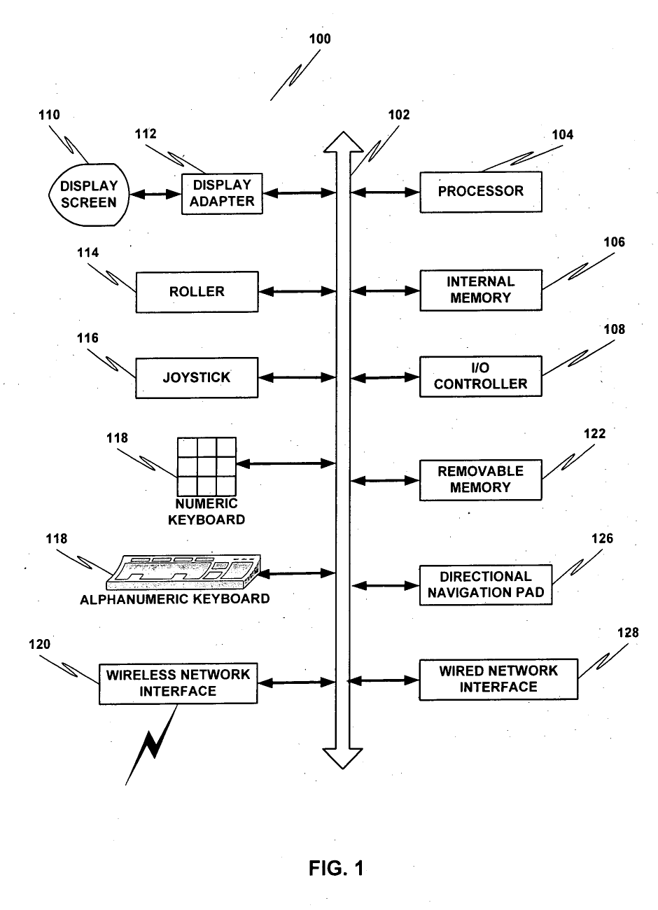

FIG. 1 depicts a block diagram of a computer system 100 suitable for implementing aspects of the present invention. As shown in FIG. 1, system 100 includes a bus 102 which interconnects major subsystems such as a processor 104, an internal memory 106 (such as a RAM), an input/output (I/O) controller 108, a removable memory (such as a memory card) 122, an external device such as a display screen 110 via display adapter 112, a roller-type input device 114, a joystick 116, a numeric keyboard 118, an alphanumeric keyboard 118, directional navigation pad 126 and a wireless interface 120. Many other devices can be connected. Wireless network interface 120, wired network interface 128, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 1 to be present to practice the present invention. Furthermore, the devices and subsystems may be interconnected in different ways from that shown in FIG. 1. Code to implement the present invention may be operably disposed in internal memory 106 or stored on storage media such as removable memory 122, a floppy disk, a thumb drive, a CompactFlash® storage device, a DVD-R (“Digital Versatile Disc” or “Digital Video Disc” recordable), a DVD-ROM (“Digital Versatile Disc” or “Digital Video Disc” read-only memory), a CD-R (Compact Disc-Recordable), or a CD-ROM (Compact Disc read-only memory).

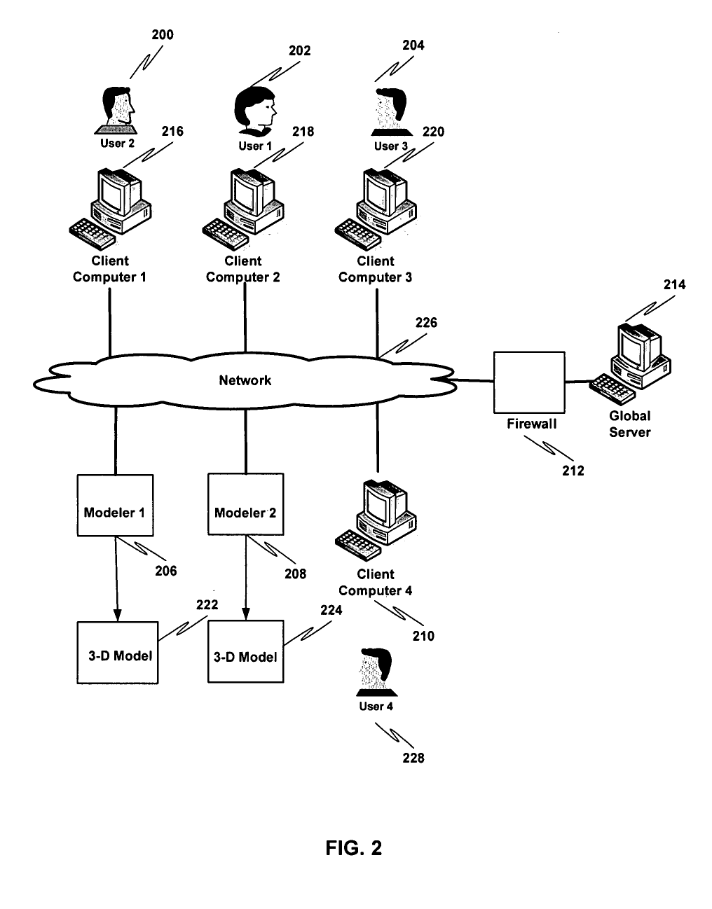

FIG. 2 is a block diagram that illustrates a system for rapid prototyping in accordance with one embodiment of the present invention. As shown in FIG. 2, a system for rapid prototyping comprises one or more client computers (216, 218, 220, 210) coupled to a network 226 and configured to interface with a user (200, 202, 204, 228) to register one or more modelers (206, 208), and to interface with the one or more modelers (206, 208) in producing one or more three-dimensional models (222, 224). One or more modelers (206, 208) are coupled to network 226 and configured to receive one or more builds from the one or more client computers (216, 218, 220, 210) and produce one or more models (222, 224) based on the one or more builds. Global server 214 is coupled to network 226 through firewall 212 and is configured to interface with the one or more client computers (216, 218, 220, 210) in registering the one or more modelers (206, 208).

Global server 214 may also be configured to receive diagnostics from the one or more modelers (206, 208) and provide feedback to users (200, 202, 204, 228) based upon an analysis of the diagnostics. The feedback may include a diagnosis of potential problems concerning the one or more modelers. The diagnostics may also be used to improve future modeler components.

Global server 214 may also be configured to provide upgrades to the one or more modelers (206, 208). The upgrades may comprise software code or data. Upon successful registration of the one or more modelers, the one or more modelers are activated.

In operation, a user (200, 202, 204, 228) receives a modeler (222, 224) and interfaces with a web server of the modeler (222, 224) via network 226 using client computer (216, 218, 220, 210) to register the modeler (206, 208) with a global server 214. According to one embodiment of the present invention, registration comprises downloading software to client computer (216, 218, 220, 210) from global server 214 or a modeler (206, 208). According to another embodiment of the present invention, the software is downloaded to client computer (216, 218, 220, 210) separate from the registration process. The downloaded software is for use in previewing one or more builds using client computer (216, 218, 220, 210), and for submitting the one or more builds from client computer (216, 218, 220, 210) to a modeler (206, 208).

Upon registering a modeler (206, 208), a user (200, 202, 204, 228) may use a client computer (216, 218, 220, 210) to create, preview, and submit a build to a modeler (206, 208). Once submitted to a modeler (206, 208), a build is queued for building a model based on the build. While a build is queued, user (200, 202, 204, 228) may use client computer (216, 218, 220, 210) to view builds in the queue, and to modify properties of the builds in the queue. By way of example, user (200, 202, 204, 228) may change the order of builds in a queue or delete one or more builds from a queue.

According to one embodiment of the present invention, a modeler (206, 208) provides diagnostics to global server 214. The diagnostics include information about a build and the status of a modeler (206, 208). Global server 214 receives the diagnostics, analyzes the diagnostics, and provides feedback based on an analysis of the diagnostics.

According to another embodiment of the present invention, global server 214 provides the modelers (206, 208) with software or data upgrades.

The illustration of embodiments of the present invention showing particular numbers of client computers, diagnostics computers, and modelers is not intended to be limiting in any way. Embodiments of the present invention apply to systems for rapid prototyping having any number of client computers, any number of diagnostics computers, and any number of modelers.

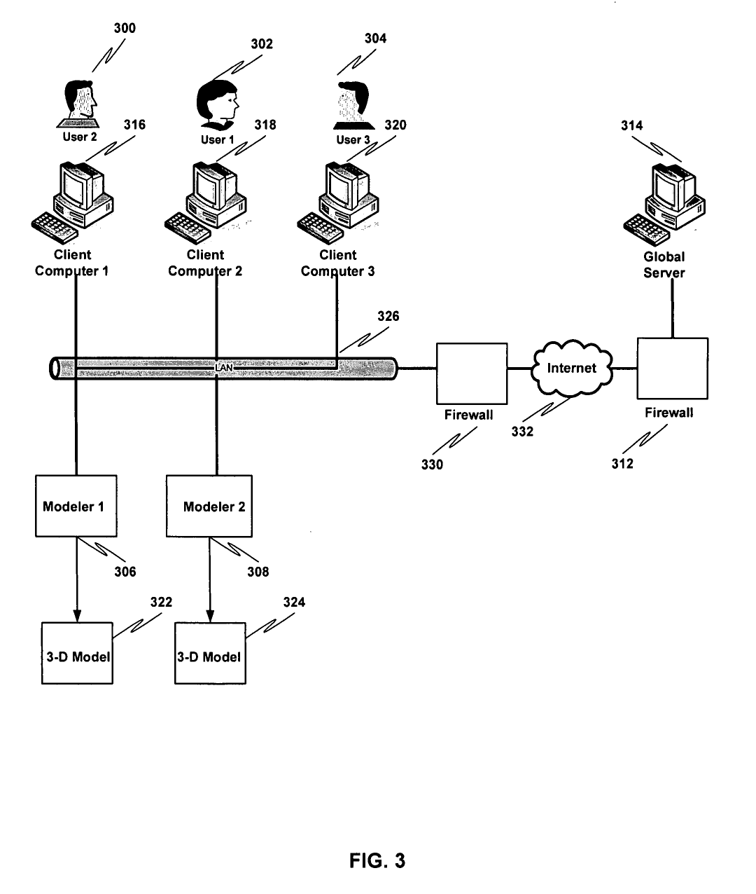

FIG. 3 is a block diagram that illustrates a system for rapid prototyping in accordance with one embodiment of the present invention. FIG. 3 is similar to FIG. 2, except users (300, 302, 304) in FIG. 3 are coupled to LAN 326, which is coupled to Internet 332 and protected by firewall 330. Global server 314 is also coupled to Internet 332 but is protected by a separate firewall 312.

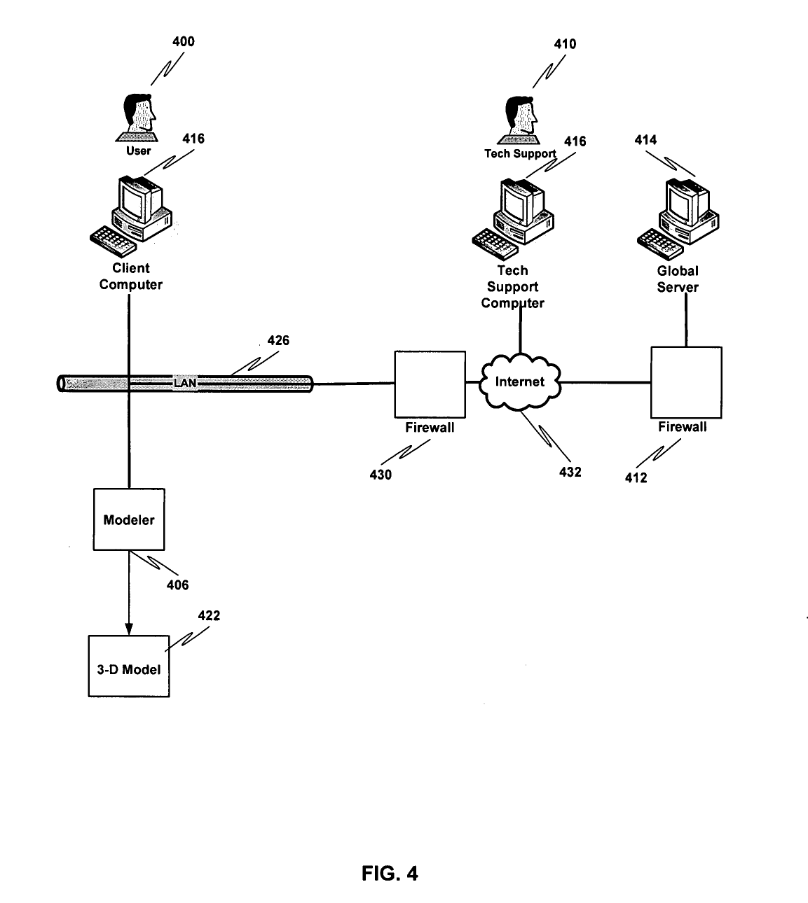

FIG. 4 is a block diagram that illustrates a system for rapid prototyping in accordance with one embodiment of the present invention. As shown in FIG. 4, global server 414 is configured to be a proxy between tech support 410 and one or more modelers 406. In this embodiment of the present invention, a system for rapid prototyping comprises one or more client computers 416 coupled to a LAN 426 and configured to interface with a user 400 to register one or more modelers 406 and to interface with the one or more modelers 406 in producing one or more three-dimensional models 422. The one or more client computers 416 and the one or more modelers 406 are also coupled to Internet 432 through firewall 430. The one or more client computers 416 are also configured to contact tech support 410 to request assistance. The one or more client computers 416 are further configured to receive instructions from tech support 410 to connect to one or more modelers 406 using the user's browser on the one or more client computers 416. The one or more client computers 416 are further configured to receive instructions from tech support 410 to command the one or more modelers 406 to initiate remote diagnostics. The one or more client computers 416 are also configured to terminate the diagnostics session.

Still referring to FIG. 4, one or more modelers 406 are coupled to LAN 426 and configured to receive one or more builds from the one or more client computers 416 and produce one or more models 422 based on the one or more builds. The one or more modelers 406 are also configured to receive a command from client computer 416 to initiate remote diagnostics. The one or more modelers 406 are further configured to connect to global server 414 to establish a diagnostics session with global server 414. The one or more modelers 406 are also configured to receive one or more instructions from global server 414, and to generate one or more log files responsive to the one or more instructions. The one or more modelers 406 are further configured to send the one or more log files to tech support 410.

Still referring to FIG. 4, global server 414 is coupled to network 432 through firewall 412 and is configured to interface with the one or more client computers 416 in registering the one or more modelers 406. Global server 414 is also configured to receive diagnostics from the one or more modelers 406 and provide feedback to users 400 based upon an analysis of the diagnostics. The feedback may include a diagnosis of potential problems concerning the one or more modelers 406. Examples of potential problems may include temperature sensoring being out of the preset desired temperature range or motors not being actuated within preset time ranges. The diagnostics may also be used to improve future modeler components. Upon successful registration of the one or more modelers, the one or more modelers are activated. Global server 414 is further configured to connect with the one or more modelers 406 to establish a session. Global server 414 is also configured to receive one or more diagnostics commands from tech support 410 and to send one or more instructions to the one or more modelers 406 in response to the one or more diagnostics commands.

In operation, user 400 contacts tech support 410 to request assistance. Tech support 410 connects to global server 414 and instructs end user 400 to connect to the one or more modelers 406 using the user's browser. Tech support 410 also instructs user 400 to command the one or more modelers 406 to initiate remote diagnostics. The one or more modelers 406 connect to global server 414 to establish a session with global server 414. Upon seeing the modeler's session with global server 414, tech support 410 sends one or more diagnostics commands to global server 414. Global Server 414 sends one or more instructions to the one or more modelers 406 in response to the one or more diagnostics commands. The one or more modelers 406 generate one or more log files responsive to the one or more instructions. The one or more modelers 406 send the one or more log files to tech support 400. Tech support 410 reviews the one or more log files to diagnose problems, and sends new instructions to modeler 406 if required. The diagnostics session may be terminated by user 400, or by tech support 410.

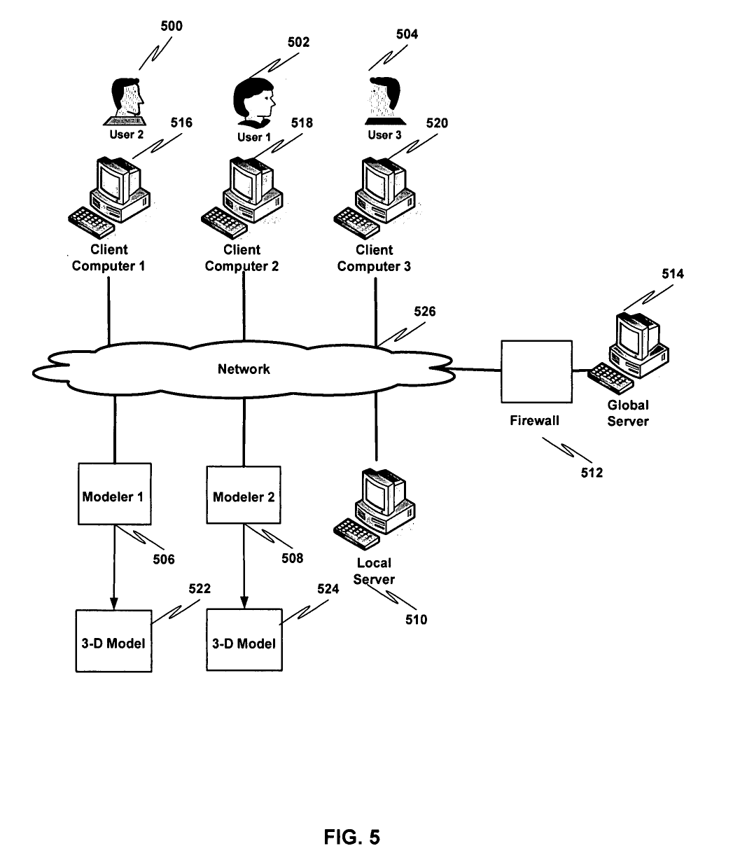

FIG. 5 is a block diagram that illustrates a system for rapid prototyping in accordance with one embodiment of the present invention. FIG. 5 is similar to FIG. 2, except client computer 210 of FIG. 2 is replaced by local server 510 in FIG. 5. Local server 510 is configured to handle the queuing of builds submitted by users (500, 502, 504) via client computers (516, 518, 520). According to one embodiment of the present invention, local server 510 determines which of the one or more modelers (506, 508) receive each of the builds that local server 510 maintains in a queue. According to another embodiment of the present invention, local server 510 is configured to maintain the configuration of the one or more modelers (506, 508). According to another embodiment of the present invention, local server 510 is configured to report on the status of the one or more modelers, and on the status of the one or more builds in the queue maintained by the local server 510.

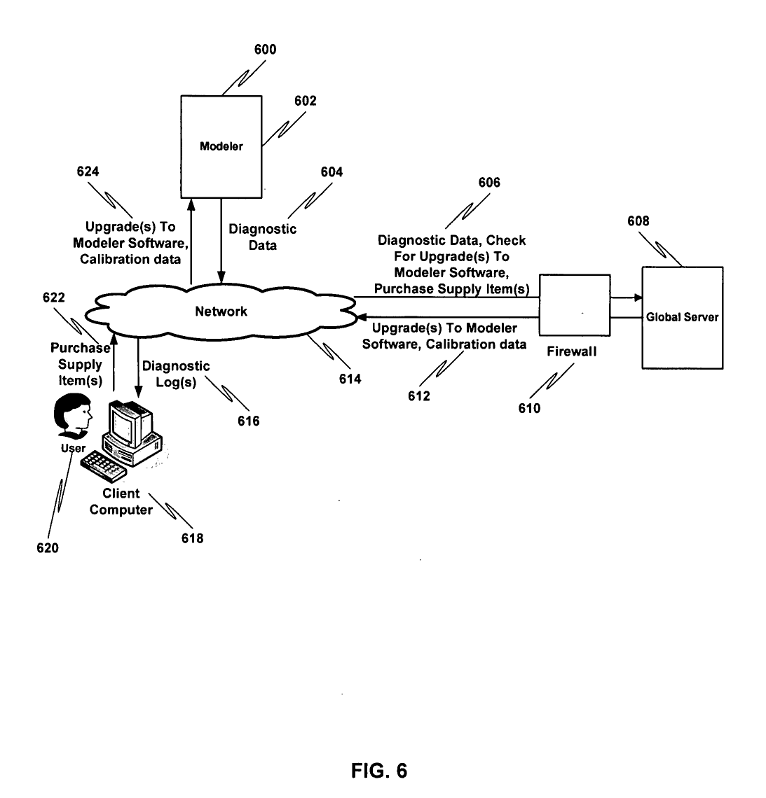

FIG. 6 is a block diagram that illustrates a system for rapid prototyping in accordance with one embodiment of the present invention. As shown in FIG. 6, a system for rapid prototyping comprises a modeler 600 coupled to network 614 and configured to receive calibration data and one or more upgrades to modeler software code or data (624). Modeler 600 is also configured to provide diagnostic data 604. Client computer 618 is coupled to network 614 and is configured to receive diagnostic data 616 and to send purchase requests for modeler supplies 622. Global server 608 is coupled to network 614 through firewall 610 and is configured to receive diagnostic data 606, check for upgrades to modeler software code or data, and receive purchase requests 606 for one or more modeler supplies. Global server 608 is also configured to send calibration data and one or more upgrades to modeler software code or data 612.

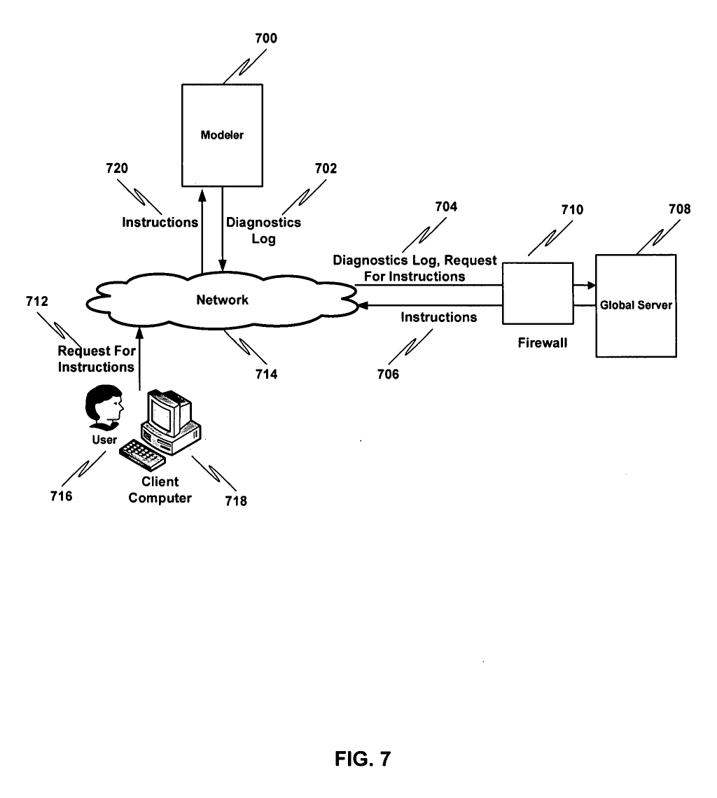

FIG. 7 is a block diagram that illustrates a system for rapid prototyping in accordance with one embodiment of the present invention. FIG. 7 is similar to FIG. 6, except the user in FIG. 7 “pulls” instructions from global server 708 via client computer 718. FIG. 7 illustrates a system and method for iteratively testing one or more modeler parameters by repeatedly instructing the modeler 700 to perform one or more actions, analyzing modeler diagnostics, and possibly instructing the modeler to perform further actions. As shown in FIG. 7, a system for rapid prototyping comprises one or more modelers 700 coupled to network 714 and configured to receive instructions 720 and send diagnostics log 702. One or more client computers 718 are coupled to network 714 and are configured to send a user's request for instructions 712 to global server 708. Global server 708 is coupled to network 714 through firewall 710 and is configured to receive diagnostics log 704 from modeler 700 via client computer 718 and a request for instructions from user 716. Global server 708 is also configured to, upon receiving the request for instructions 712, analyze the diagnostics log 704 and provide user 716 with feedback or instructions 706 based on the analysis. One or more modelers 700 are configured to connect to global server 708 from within firewall 710, using normal Internet communication channels, and receive instructions from global server 708 via client computer 718. According to one embodiment of the present invention, the requested instructions comprise a request for active diagnostics, where a user clicks a button of a graphical user interface to allow a remote global server personnel to remotely diagnose the model to determine a fix or workaround.

In operation, user 716 requests instructions using client computer 718 from global server 708. Global server 708 sends instructions 706 to client computer 718, which forwards the instructions 720 to modeler 700. Modeler 700 executes the instructions 720 and generates a diagnostics log 702 and sends the diagnostics log 702 to client computer 718. Client computer 718 sends the diagnostics log 704 to global server 708. Global server 708 analyzes the diagnostics log 704 and sends updated instructions 706 to client computer 718, which forwards the updated instructions 720 to modeler 700. The above steps may be repeated multiple times to test one or more modeler parameters. Examples of modeler parameters include motor speeds, motor actuation times, and temperatures.

According to another embodiment of the present invention, global server 708 communicates directly with modeler 700 with approval of user 716, such that user 716 is not an intermediary for communications between modeler 700 and global server 708.

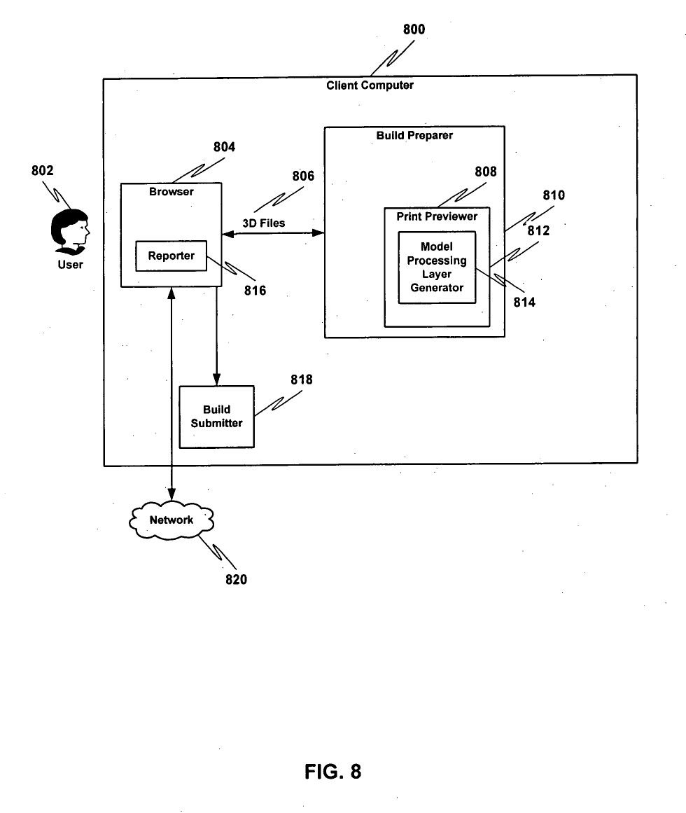

FIG. 8 is a block diagram that illustrates a client computer for rapid prototyping in accordance with one embodiment of the present invention. As shown in FIG. 8, client computer 800 comprises a build preparer 810 configured to prepare a build. Client computer 800 also comprises a browser 804 configured to render information to user 802, and to receive input from user 802. Browser 804 is also configured to, via network 820, register one or more modelers and send one or more builds to one or more modelers. According to one embodiment of the present invention, client computer 800 is configured to, as a part of modeler registration, receive print previewer 808 from the modeler via a web server embedded in the modeler.

Browser 804 also comprises a reporter 816 configured to report on the status of client computer 800. Client computer 800 also comprises a build submitter 818 configured to submit a build from build preparer 810 to a modeler via network 820. Build preparer 810 further comprises a print previewer 808 configured to preview a build before it is submitted to a modeler. Print previewer 808 comprises a model processing layer generator 814 configured to generate one or more layers of a three dimensional model described by a build. The process used to generate the one or more layers is based at least in part on the type of RP employed. For example, layer generation may comprise raster scanning. Alternatively, layer generation may comprise creating an image of each layer as it is formed by the particular RP process. In stereolithography, this layering process is called “slicing.”

In operation, browser 804 receives input from user 802 required to register a modeler with a global server. Browser 804 interfaces with the global server via network 820 to provide the information required to register the modeler. The registration of the modeler may include downloading print previewer 808 from the modeler via a web server embedded in the modeler. After registering a modeler, user 802 interfaces with client computer 800 via browser 804 to create one or more builds describing a three-dimensional model. The user may preview an image of the three dimensional model using browser 804. When the user 802 indicates a build is ready to be submitted to a modeler, the build is submitted via build submitter 818.

According to another embodiment of the present invention, a modeler is configured to perform the model processing layer generation functions described above with respect to model processing layer generator 814. According to another embodiment of the present invention, model processing layer generation functionality is distributed between one or more modelers and one or more client computers.

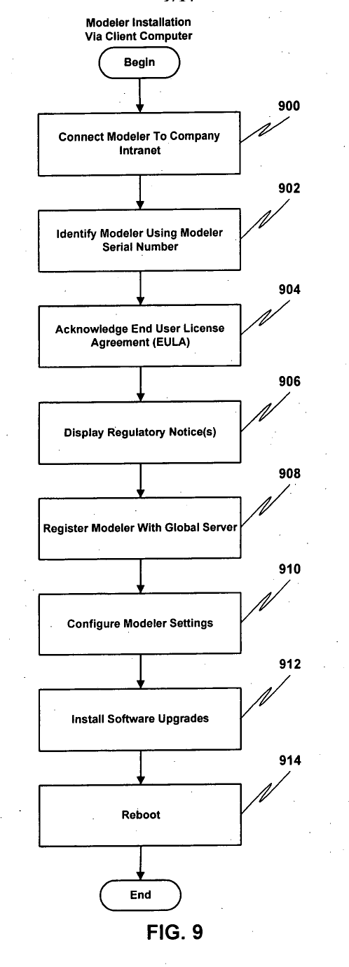

FIG. 9 is a flow diagram that illustrates a method for modeler installation for rapid prototyping in accordance with one embodiment of the present invention. The processes illustrated in FIG. 9 may be implemented in hardware, software, firmware, or a combination thereof. When a user installs a modeler, At 900, the modeler is connected to a company network or Intranet. At 902, the modeler is identified to a global server via a Web browser. The Web browser may use standard TCP/IP port 80 commands to communicate the identification information to the global server. According to one embodiment of the present invention, the identification is based on the modeler's serial number. Those of ordinary skill in the art will recognize that other identification methods are possible. At 904, an end user license agreement (EULA) is acknowledged. According to one embodiment of the present invention, initialization of the modeler fails if the EULA is not acknowledged.

According to one embodiment of the present invention, acknowledgement of the EULA may be required before the user is allowed to subscribe to one or more online services. Example online services include downloading software from the modeler. By way of example, a user may subscribe for receipt of remote diagnostics or online periodic upgrades. According to one embodiment of the present invention, a fee is charged for periodic upgrades. The downloaded software may include software for use in submitting jobs from a client computer to a modeler. The downloaded software may also include software that allows the user of a client computer to preview a build by providing an image of the three-dimensional model described by the build. Example online services may also include a remote diagnostics service, and a service providing for the purchase of modeler material.

At 906, one or more regulatory notices are displayed. Example regulatory notices include environmental policies relating to the disposal of modeler raw material. At 908, the modeler is registered with the global server. Registering a modeler may initiate the warranty period of the modeler. At 910, one or more modeler settings are configured. Example modeler settings that may be included are the modeler IP address, hostname, and modeler administrator email address. Configuring modeler settings may also include establishing an administrator account for the modeler, and establishing security settings. According to one embodiment of the present invention, the one or more security settings indicate the permissions of different client computers. According to another embodiment of the present invention, the one or more security settings indicate the permissions of different users. Examples of the types of permissions include the ability to hold, delete, or modify jobs in a build. According to one embodiment of the present invention, the permissions for each client are set up for each modeler on the intranet. At 912, software upgrades, if available, are downloaded and installed on the modeler. According to one embodiment of the present invention, the one or more software upgrades are downloaded from a global server. At 914, the modeler is rebooted to complete the installation.

Once configured, builds describing models may be submitted and processed through the build queue. Model manipulation and slicing may occur at the client computer, at a local server, at a global server, or some combination thereof. Error, status, or diagnostics messages among others may either be posted to the user's open modeler web page through the browser or sent via email message to the administrator or to clients.

According to another embodiment of the present invention, the user need not orient the parts in order to submit them via a client computer to a modeler.

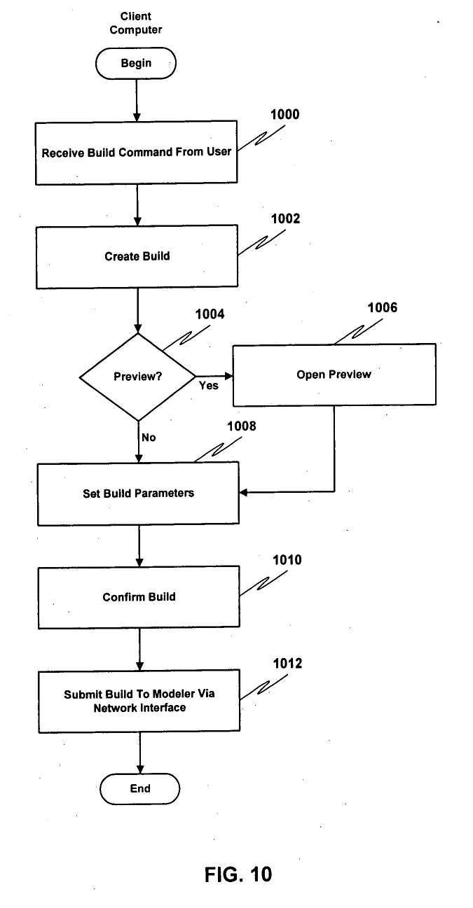

FIG. 10 is a flow diagram that illustrates a high-level method for rapid prototyping from the perspective of a client computer in accordance with one embodiment of the present invention. The processes illustrated in FIG. 10 may be implemented in hardware, software, firmware, or a combination thereof. At 1000, a command to create a build is received from a user. At 1002, a build is created. The creation of the build includes generating descriptive information for use by a modeler in creating a three-dimensional model. At 1004, a determination is made regarding whether the build should be previewed. If the build should be previewed, a preview of the build is opened at 1006. At 1008, parameters of the build are set. By way of example, the user may set a build style, select modeler raw material, or set a name for a build. At 1010, the user asked to confirm that the build should be submitted to a modeler. If the build is confirmed, it is submitted to a modeler via a network interface at 1012.

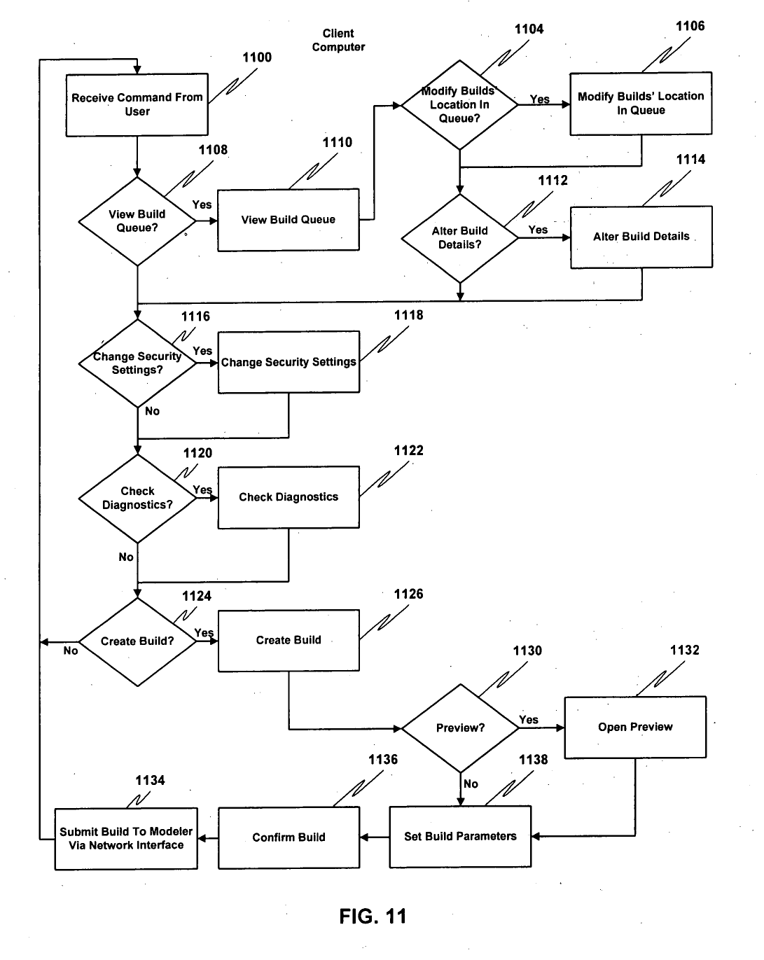

FIG. 11 is a flow diagram that illustrates a low-level method for rapid prototyping from the perspective of a client computer in accordance with one embodiment of the present invention. The processes illustrated in FIG. 11 may be implemented in hardware, software, firmware, or a combination thereof. At 1100, a command is received from a user. At 1108, a determination is made regarding whether the current build queue should be viewed. If the user current build queue should be viewed, the user is presented with the build queue for viewing at 1110. Upon viewing the build queue, the user may indicate a desire to modify a location of a build in the build queue or to alter one or more details of one or more builds. If it is determined at 1104 that the location of a build in the build queue should be modified, the user is allowed to do so at 1106. If it is determined at 1112 that the details of one or more builds should be altered, the user is allowed to do so at 1114.

At 1116, a determination is made regarding whether the one or more security settings should be changed. If the one or more security settings should be changed, the user is allowed to do so at 1118. At 1120, a determination is made regarding whether one or more diagnostics should be checked. If the one or more diagnostics should be checked, the user is allowed to do so at 1122. At 1124, a determination is made regarding whether a build should be created. If a build should be created, at 1126, a build is created. At 1130, a determination is made regarding whether a build should be previewed. If the build should be previewed, a preview of the build is opened at 1132. At 1138, various parameters of the build are set. By way of example, the user may set a build style. At 1136, the user asked to confirm that the build should be submitted to a modeler. If the build is confirmed, it is submitted to a modeler via a network interface at 1134.

FIG. 11 illustrates one sequence of tasks in accordance with one embodiment of the present invention. The tasks illustrated in FIG. 11 may be performed in other sequences in accordance with other embodiments of the present invention. By way of example, a user check diagnostics (1122) after creating a build (1126), change security settings (1118) after checking diagnostics (1122), or view a build queue (1110) after creating a build (1126). The tasks illustrated in FIG. 11 may also be performed with other tasks illustrated in FIG. 11.

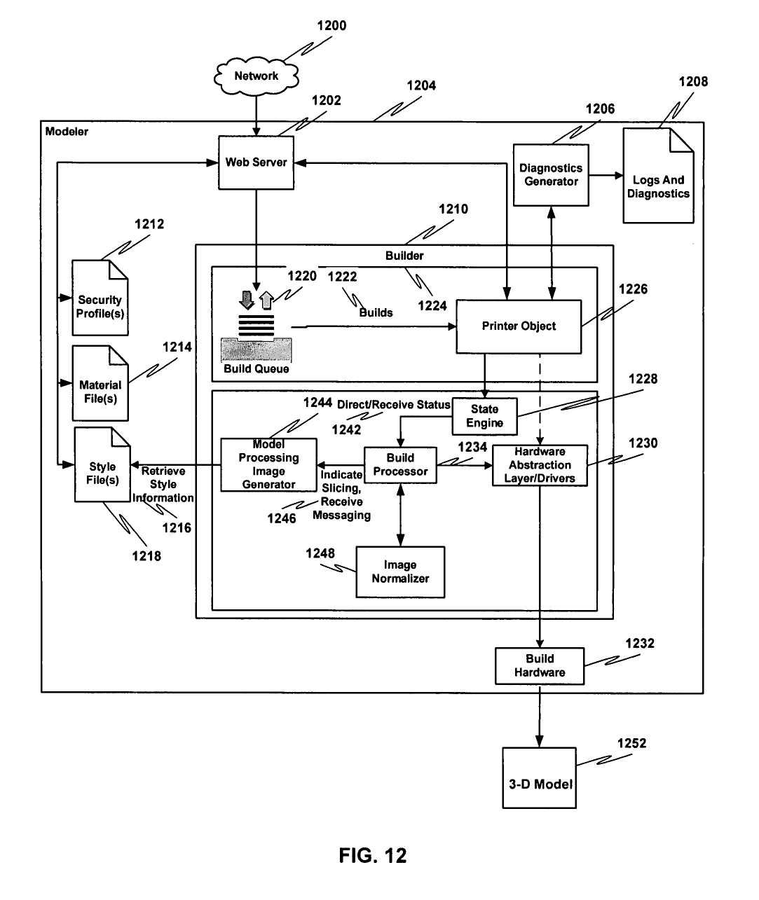

FIG. 12 is a block diagram that illustrates a modeler for rapid prototyping in accordance with one embodiment of the present invention. As shown in FIG. 12, modeler 1204 comprises a web server 1202, a diagnostics generator 1206, a builder 1210, and build hardware 1232. Web server 1202 is coupled to network 1200 and is configured to manage communication between modeler 1204 and the network browsers of client computers. Builder 1210 is coupled to web server 1202 and is configured to interface with one or more client computers during registration of the modeler 1204, to provide the one or more client computers with software used in submitting one or more builds to a modeler 1204. Web server 1202 is also configured to receive one or more builds via network 1200 and send the one or more builds to builder 1210. Web server 1202 is also configured to receive one or more diagnostics from diagnostics generator 1206 and send them via network 1200. Web server 1202 is also configured to receive calibration data via network 1200.

Diagnostics generator 1206 is coupled to build processor 1210 and is configured to generate one or more diagnostics describing the operation of modeler 1204, including the status of particular builds. Builder 1210 is configured to maintain a build queue 1220 which feeds builds 1222 to a printer object. State engine 1234 is configured to maintain the current state of the modeler. Build processor 1234 is configured to provide build hardware 1232 with the information required to build a three-dimensional model described by a build. Model image processing generator equipment may comprise any image generator equipment commonly used in RP systems, including but not limited to a DLP imager. Model image processing generator 1244 is configured to generate an image of a three-dimensional model described by a build. Image normalizer 1248 is configured to normalize an image of a three-dimensional model described by a build using updated calibration data. Hardware abstraction layer/drivers 1230 is configured to interface between application-level modules in modeler 1204, and the build hardware 1232 used to produce one or more physical representations of the one or more three-dimensional models. Build hardware 1232 is configured to produce one or more three-dimensional models 1252 based on one or more builds.

According to one embodiment of the present invention, modeler 1204 is further configured to, when a new device is installed in the modeler 1204, automatically check with a global server for information for use in optimizing system performance for a given hardware, software, or supply item.

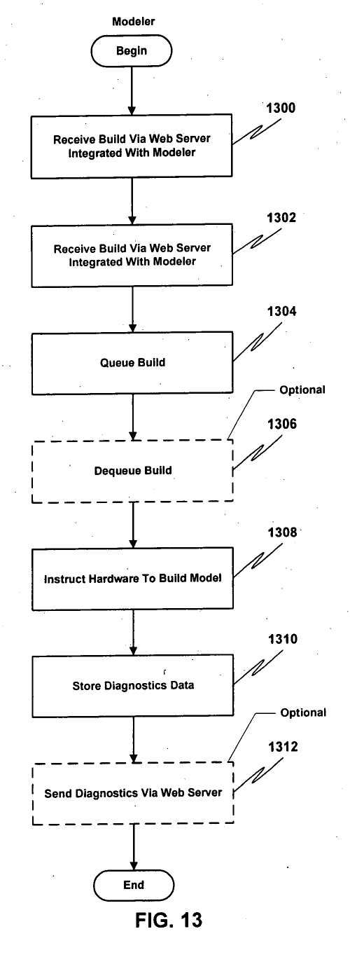

FIG. 13 is a flow diagram that illustrates a method for rapid prototyping from the perspective of a modeler in accordance with one embodiment of the present invention. The processes illustrated in FIG. 13 may be implemented in hardware, software, firmware, or a combination thereof. At 1300, a three-dimensional modeler is connected to a network via a web server integrated with the three-dimensional modeler. At 1302, a build is received via a web server integrated with the modeler. At 1304, the build is put in a queue of builds waiting processing wherein the build is used by the modeler to create a physical representation of the model described by the build. At 1306, the build is optionally removed from the queue when the modeler is ready to create a physical representation of the model described by the build. At 1308, the modeler hardware is instructed to build a model. At 1310, diagnostics data is stored. The diagnostics data may be stored in a data store associated with the modeler. The modeler may comprise the data store. Alternatively, the data store may be a network data store. At 1312, diagnostics are optionally sent via the web server.

The diagnostics are for use in data mining modeler-related information. Specifically, the diagnostics are for use in analyzing performance issues of a modeler, and in understanding how a user uses a modeler so that the user may be provided appropriate feedback. By way of example, an analysis of diagnostics that indicate a high amount of resin use could trigger an offer from a resin supplier for a discounted rate on resin. As a further example, an analysis of diagnostics that indicate a high modeler cycle time may trigger a message advising the user that the modeler may need a new motor or other parts that may be worn by use.

According to one embodiment of the present invention, one or more build in a queue may be repositioned, thus changing the order in which a modeler creates physical representations of three-dimensional models. According to another embodiment of the present invention, two or more builds in a queue may be combined to form a single build in the queue.

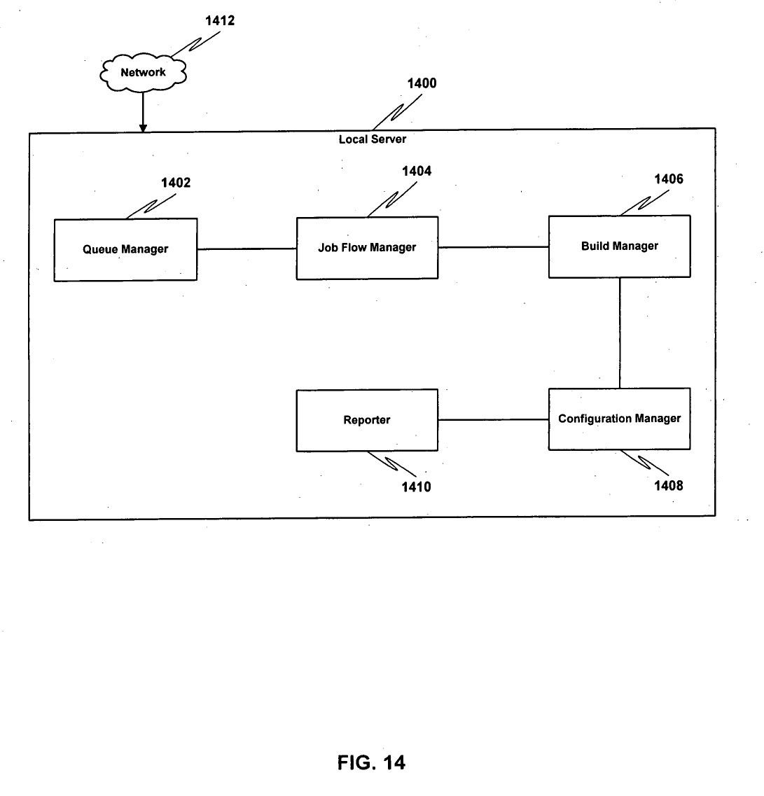

FIG. 14 is a block diagram that illustrates a local server for rapid prototyping in accordance with one embodiment of the present invention. As shown in FIG. 14, local server comprises a queue manager 1402, a job flow manager 1404, a build manager 1406, a configuration manager 1406, and a reporter 1410. Queue manager 1402 is configured to manage a queue of builds waiting processing by a modeler. Job flow manager 1404 is configured to manage the flow of jobs. Build manager 1406 is configured to manage one or more builds. Configuration manager 1406 is configured to maintain the current configuration of modelers and builds. Reporter 1410 is configured to report on the status of build queues and the status of builds in the build queues.

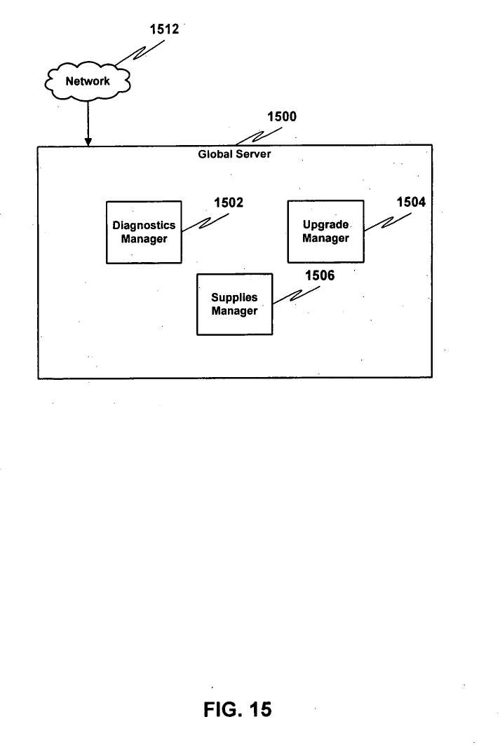

FIG. 15 is a block diagram that illustrates a global server for rapid prototyping in accordance with one embodiment of the present invention. As shown in FIG. 15, global server 1500 comprises a diagnostics manager 1502, an upgrade manager 1504, and a supplies manager. Diagnostics manager 1502 is configured to receive diagnostics from one or more modelers, analyze the diagnostics, and provide feedback or instructions based on the analysis. Upgrade manager 1504 is configured to provide one or more upgrades to one or more modelers. The one or more upgrades may comprise more recent information or corrected information for use by the one or more modelers in producing three dimensional models. By way of example, the one or more upgrades may comprise modeler calibration data, modeler software, or data files. According to one embodiment of the present invention, one or more upgrades are provided to one or more modelers in response to a request from on or more users. According to another embodiment of the present invention, the one or more upgrades are provided to one or more modelers automatically when the upgrade becomes available, or when an analysis of diagnostics from the one or more modelers indicates one or more upgrades should be provided.

Supplies manager 1506 is configured to receive one or more orders for modeler supplies, determine if the one or more supplies are in inventory, and if the one or more supplies are in inventory, fulfill the order. Examples of supplies purchased for a modeler include build pads or resin cartridges. According to one embodiment of the present invention, one or more orders for supplies are issued automatically by one or more suppliers when the user's inventory of particular supply items falls below a predetermined threshold.

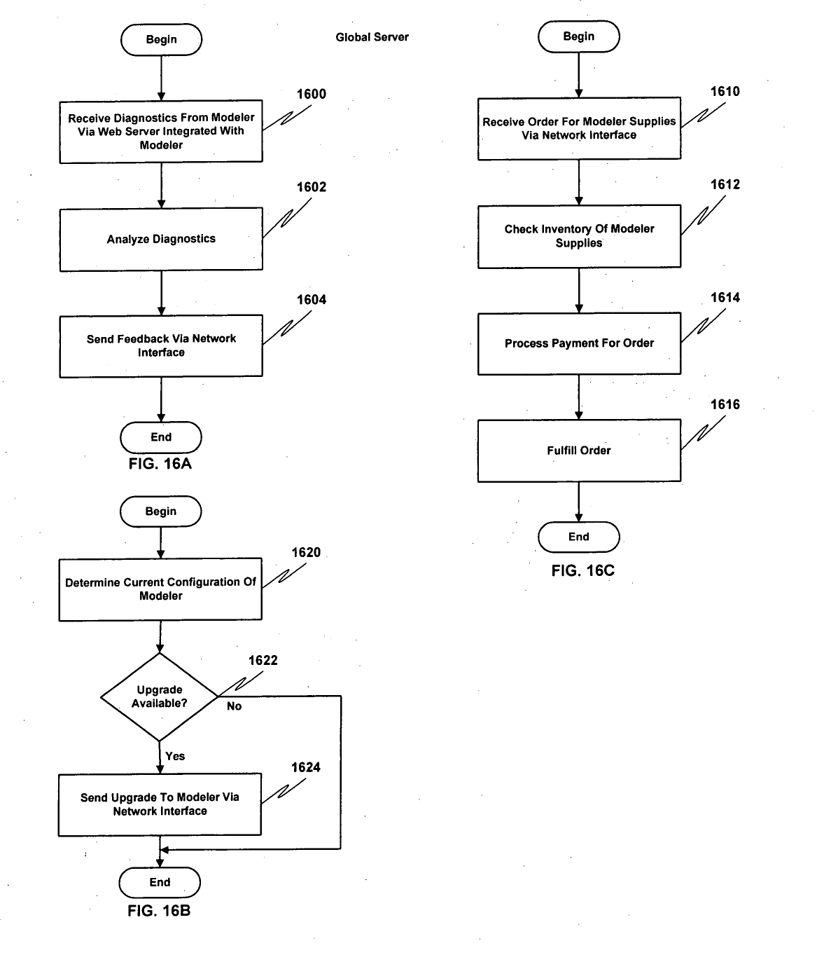

FIG. 16A is a flow diagram that illustrates a method for rapid prototyping from the perspective of a global server in accordance with one embodiment of the present invention. The processes illustrated in FIG. 16A may be implemented in hardware, software, firmware, or a combination thereof. At 1600, diagnostics from one or more modelers are received via web servers integrated with the respective one or more modelers. At 1602, the diagnostics are analyzed. At 1604, feedback based on the analysis of the diagnostics is sent via a network interface. The feedback may be sent to one or more client computers in the network, one or more modelers in the network, or both.

FIG. 16B is a flow diagram that illustrates a method for rapid prototyping from the perspective of a global server in accordance with one embodiment of the present invention. The processes illustrated in FIG. 16B may be implemented in hardware, software, firmware, or a combination thereof. At 1620, the current configuration of a modeler is determined. At 1622, a determination is made regarding whether one or more upgrades are available for the modeler in a network. If one or more upgrades are available for the modeler, the upgrade is sent using a network interface at 1624 for receipt by the modeler via a web server integrated with the modeler. Upgrades for client computers are sent to one or more client computers, and upgrades for modelers are sent to one or more modelers.

FIG. 16C is a flow diagram that illustrates a method for rapid prototyping from the perspective of a global server in accordance with one embodiment of the present invention. The processes illustrated in FIG. 16C may be implemented in hardware, software, firmware, or a combination thereof. At 1610, an order for modeler supplies is received via a network interface. According to one embodiment of the present invention, the order is received from a three-dimensional modeler. According to another embodiment of the present invention, the order is received from a client computer. At 1612, the current inventory of modeler supplies is checked for the supplies indicated in the order. If the supplies are in inventory, payment for the order is processed at 1614. At 1616, the order is fulfilled. The order may be fulfilled by sending the supplies to the requestor, or by instructing an agent to send the supplies to the requester.

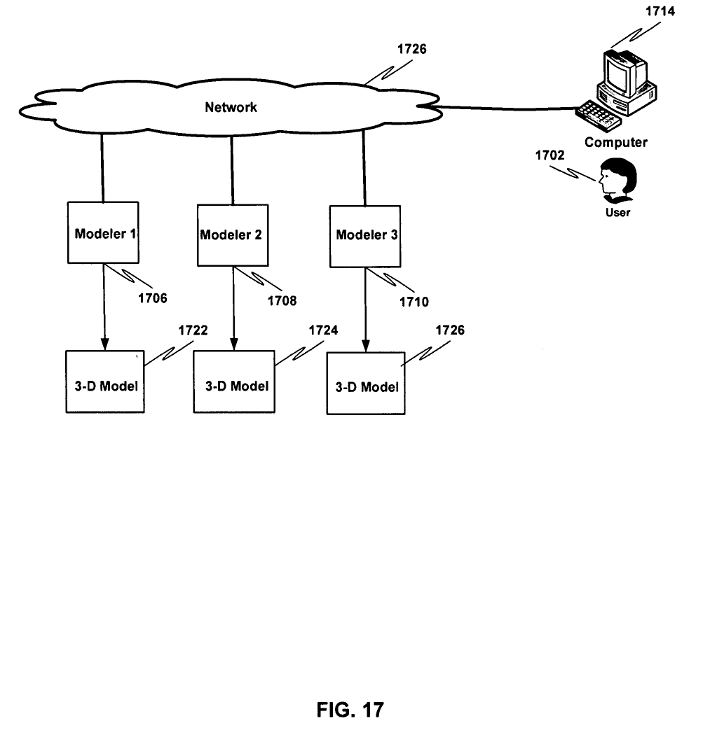

FIG. 17 is a block diagram that illustrates a system for rapid prototyping in accordance with one embodiment of the present invention. As shown in FIG. 17, a system for rapid prototyping comprises one or more computers 1714 coupled to a network 1726 and configured to interface with a user 1702 to register one or more modelers (1706, 1708, 1710), and to interface with the one or more modelers (1706, 1708, 1710) in producing one or more three-dimensional models (1722, 1724, 1726). One or more modelers (1706, 1708, 1710) are coupled to network 1726 and configured to receive one or more builds from the one or more computers 1714 and produce one or more models (1722, 1724, 1726) based on the one or more builds. The one or more modelers (1706, 1708, 1710) are further configured to detect each other's presence, and to share information directly with each other and without using a global server. The shared information may comprise the current wait time for build submitted to a particular modeler (1706, 1708, 1710), and an indication of the build material(s) currently used in a particular modeler (1706, 1708, 1710). Computer 1714 may also be configured to receive diagnostics from the one or more modelers (1706, 1708, 1710) and provide feedback to users 1702 based upon an analysis of the diagnostics. The feedback may include a diagnosis of potential problems concerning the one or more modelers. The diagnostics may also be used to improve future modeler components. Computer 1714 may also be configured to provide upgrades to the one or more modelers (1706, 1708, 1710). The upgrades may comprise software programs or data. Upon successful registration of the one or more modelers, the one or more modelers (1706, 1708, 1710) are activated.

In operation, modelers (1706, 1708, 1710) user 1702 connects to one of modelers 1706, 1708, and 1710 and initiates the process of submitting a build. If the user has connected with modeler 1706, modeler 1706 examines details of the build to determine whether modeler 1708 or modeler 1710 could perform the build more efficiently in terms of time or cost. If one of modeler 1708 or modeler 1710 could perform the build more efficiently, modeler 1708 redirects the user 1702 to the modeler that can perform the build more efficiently.

It may be also useful to mark the build material containers used in the modelers with radio frequency identification tags (RFID Technology) so as to ensure accurate build material replacement and to avoid the costly error of unwanted mixing of different build materials in a build. The user can be alerted prior to starting up the modeler with a new build material container whether that container contains the right build material. This RFID technology as used in RP applications is described in U.S. patent application Ser. No. 11/240,819 (Attorney Docket No. USA.425) and may be adapted to any of the present embodiments. This patent application is incorporated herein by reference in its entirety.

According to one embodiment of the present invention, an apparatus comprises: means for connecting a three-dimensional modeler to a network via a web server integrated with said three-dimensional modeler; and
means for registering said three-dimensional modeler with a global server in said network, said registering based at least in part on an identifier describing said three-dimensional modeler, said three-dimensional modeler being activated upon successful completion of said registering.

According to another embodiment of the present invention, an apparatus comprises:
means for receiving from a user a command to create a build, said build comprising information for use in generating a physical representation of a three-dimensional model;
means for creating said build; and
means for submitting said build to a three-dimensional modeler in a network using a web server integrated with said three-dimensional modeler.

According to another embodiment of the present invention, an apparatus comprises:
means for connecting a three-dimensional modeler to a network via a web server integrated with said three-dimensional modeler;
means for receiving a build via said web server, said build comprising information for use in generating a physical representation of a three-dimensional model;
means for placing said build in a queue comprising one or more builds awaiting processing; and
means for instructing hardware of said modeler to create said physical representation.

According to another embodiment of the present invention, an apparatus comprises:
means for receiving diagnostics of a three-dimensional modeler from a global server configured to establish a session between said global server and said modeler, said modeler coupled to a network via a first firewall, said global server coupled to said network via a second firewall, said three-dimensional modeler for generating a physical representation of a three-dimensional model, said diagnostics comprising information about a build, said build comprising information for use in said generating; means for analyzing said diagnostics; and
means for sending feedback via said global server, said feedback based at least in part on said analyzing.

According to another embodiment of the present invention, an apparatus comprises:
means for receiving diagnostics from a three-dimensional modeler via a network interface, said three-dimensional modeler for generating a physical representation of a three-dimensional model, said diagnostics comprising information about a build, said build comprising information for use in said generating;
means for analyzing said diagnostics; and
means for sending feedback via said network interface, said feedback based at least in part on said analyzing.

According to another embodiment of the present invention, a program storage device that is readable by a machine embodies a program of instructions executable by the machine to perform a method, where the method comprises:
connecting a three-dimensional modeler to a network via a web server integrated with said three-dimensional modeler; and
registering said three-dimensional modeler with a global server in said network, said registering based at least in part on an identifier describing said three-dimensional modeler, said three-dimensional modeler being activated upon successful completion of said registering.

According to another embodiment of the present invention, a program storage device that is readable by a machine embodies a program of instructions executable by the machine to perform a method, where the method comprises:
receiving from a user a command to create a build, said build comprising information for use in generating a physical representation of a three-dimensional model;
creating said build; and
submitting said build to a three-dimensional modeler in a network using a web server integrated with said three-dimensional modeler.

According to another embodiment of the present invention, a program storage device that is readable by a machine embodies a program of instructions executable by the machine to perform a method, where the method comprises:
connecting a three-dimensional modeler to a network via a web server integrated with said three-dimensional modeler;
receiving a build via said web server, said build comprising information for use in generating a physical representation of a three-dimensional model;
placing said build in a queue comprising one or more builds awaiting processing; and
instructing hardware of said modeler to create said physical representation.

According to another embodiment of the present invention, a program storage device that is readable by a machine embodies a program of instructions executable by the machine to perform a method, where the method comprises:
receiving diagnostics of a three-dimensional modeler from a global server configured to establish a session between said global server and said modeler, said modeler coupled to a network via a first firewall, said global server coupled to said network via a second firewall, said three-dimensional modeler for generating a physical representation of a three-dimensional model, said diagnostics comprising information about a build, said build comprising information for use in said generating;
analyzing said diagnostics; and
sending feedback via said global server, said feedback based at least in part on said analyzing.

According to another embodiment of the present invention, a program storage device that is readable by a machine embodies a program of instructions executable by the machine to perform a method, where the method comprises:
receiving diagnostics from a three-dimensional modeler via a network interface, said three-dimensional modeler for generating a physical representation of a three-dimensional model, said diagnostics comprising information about a build, said build comprising information for use in said generating;
analyzing said diagnostics; and
sending feedback via said network interface, said feedback based at least in part on said analyzing.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method comprising:
connecting a three-dimensional modeler to a network via a web server integrated with said three-dimensional modeler; and
registering said three-dimensional modeler with a global server in said network, said registering based at least in part on an identifier describing said three-dimensional modeler, said three-dimensional modeler being activated upon successful completion of said registering.

2. The method of claim 1 wherein said successful completion of said registering requires acknowledgement of one or more end user license agreement (EULA).

3. The method of claim 1, further comprising subscribing to one or more online services.

4. The method of claim 3 wherein said one or more online services comprises a remote diagnostics service.

5. The method of claim 3 wherein said one or more online services comprises a software upgrade service.

6. The method of claim 1, further comprising downloading from said web server to at least one client computer in said network, software for use in submitting one or more builds to said modeler.

7. The method of claim 6 wherein said software comprises software for previewing a build.

8. The method of claim 1, further comprising configuring one or more security settings for said modeler.

9. The method of claim 8 wherein said one or more security settings indicate permissions of different users.

10. The method of claim 8 wherein said one or more security settings indicate permissions of different client computers.

11. The method of claim 1, further comprising:
determining a current configuration of said three-dimensional modeler in said network;
determining whether one or more upgrades to said current configuration are available; and
if said one or more upgrades to said current configuration are available, sending said one or more upgrades to said three-dimensional modeler via a network interface.

12. The method of claim 11 wherein said one or more upgrades comprises software code.

13. The method of claim 11 wherein said one or more upgrades comprises data.

14. The method of claim 13 wherein said data comprises calibration data for said three-dimensional modeler.

15. The method of claim 1, further comprising:
receiving from a requestor an order for one or more three-dimensional modeler supplies, said order received via a network interface;
checking an inventory of three-dimensional modeler supplies for said one or more three-dimensional modeler supplies;
processing payment for said order if said one or more three-dimensional modeler supplies are in said inventory; and
fulfilling said order.

16. The method of claim 15 wherein said fulfilling said order comprises sending said one or more three-dimensional modeler supplies to said requester.

17. The method of claim 15 wherein said fulfilling said order comprises instructing an agent to send said one or more three-dimensional modeler supplies to said requester.

18. The method of claim 16 wherein said requestor comprises a three-dimensional modeler.

19. A method comprising:
receiving from a user a command to create a build, said build comprising information for use in generating a physical representation of a three-dimensional model;
creating said build; and
submitting said build to a three-dimensional modeler in a network using a web server integrated with said three-dimensional modeler.

20. The method of claim 19, further comprising previewing said build before said submitting.

21. The method of claim 19, further comprising setting one or more parameters of said build before said submitting.

22. The method of claim 19, further comprising confirming said build should be submitted to said three-dimensional modeler before said submitting.

23. The method of claim 19, further comprising modifying a location of one or more builds in a build queue.

24. The method of claim 19, further comprising altering one or more details of one or more builds in a build queue.

25. The method of claim 19, further comprising changing one or more security settings.

26. The method of claim 19, further comprising checking one or more diagnostics.

27. The method of claim 26 wherein said one or more diagnostics comprises information about a build.

28. The method of claim 26 wherein said one or more diagnostics comprises information about a three-dimensional modeler.

29. A method comprising:
connecting a three-dimensional modeler to a network via a web server integrated with said three-dimensional modeler;
receiving a build via said web server, said build comprising information for use in generating a physical representation of a three-dimensional model;
placing said build in a queue comprising one or more builds awaiting processing; and
instructing hardware of said modeler to create said physical representation.

30. The method of claim 29, further comprising removing said build from said queue.

31. The method of claim 29, further comprising repositioning said build in said queue.

32. The method of claim 29, further comprising combining two or more builds in said queue.

33. The method of claim 29, further comprising sending one or more diagnostics for said build via said web server.

34. A method comprising:
receiving diagnostics of a three-dimensional modeler from a global server configured to establish a session between said global server and said modeler, said modeler coupled to a network via a first firewall, said global server coupled to said network via a second firewall, said three-dimensional modeler for generating a physical representation of a three-dimensional model, said diagnostics comprising information about a build, said build comprising information for use in said generating;
analyzing said diagnostics; and
sending feedback via said global server, said feedback based at least in part on said analyzing.

35. The method of claim 34 wherein said sending further comprises sending said feedback to one or more client computers.

36. The method of claim 34 wherein said sending further comprises sending said feedback to said three-dimensional modeler.

37. The method of claim 34 wherein said feedback comprises calibration data for said three-dimensional modeler.

38. A method comprising:
receiving diagnostics from a three-dimensional modeler via a network interface, said three-dimensional modeler for generating a physical representation of a three-dimensional model, said diagnostics comprising information about a build, said build comprising information for use in said generating;
analyzing said diagnostics; and
sending feedback via said network interface, said feedback based at least in part on said analyzing.

39. The method of claim 38 wherein said sending further comprises sending said feedback to one or more client computers.

40. The method of claim 38 wherein said sending further comprises sending said feedback to said three-dimensional modeler.

41. The method of claim 40 wherein said feedback comprises calibration data for said three-dimensional modeler.

42. An apparatus comprising a client computer configured to:
connect a three-dimensional modeler to a network via a web server integrated with said three-dimensional modeler; and
register said three-dimensional modeler with a global server in said network, said registering based at least in part on an identifier describing said three-dimensional modeler, said three-dimensional modeler being activated upon successful completion of said registering.

43. The apparatus of claim 42 wherein said successful completion of said registering requires acknowledgement of one or more end user license agreement (EULA).

44. The apparatus of claim 42 wherein said client computer is further configured to subscribe to one or more online services.

45. The apparatus of claim 44 wherein said one or more online services comprises a remote diagnostics service.

46. The apparatus of claim 44 wherein said one or more online services comprises a software upgrade service.

47. The apparatus of claim 42 wherein said client computer is further configured to download from said web server to at least one client computer in said network, software for use in submitting one or more builds to said modeler.

47. The apparatus of claim 47 wherein said software comprises software for previewing a build.

49. The apparatus of claim 42 wherein said client computer is further configured to configure one or more security settings for said modeler.

50. The apparatus of claim 49 wherein said one or more security settings indicate permissions of different users.

51. The apparatus of claim 49 wherein said one or more security settings indicate permissions of different client computers.

52. The apparatus of claim 42, further comprising a global server configured to:
determine a current configuration of said three-dimensional modeler in said network;
determine whether one or more upgrades to said current configuration are available; and
if said one or more upgrades to said current configuration are available, send said one or more upgrades to said three-dimensional modeler via a network interface.

53. The apparatus of claim 52 wherein said one or more upgrades comprises software code.

54. The apparatus of claim 52 wherein said one or more upgrades comprises data.

55. The apparatus of claim 54 wherein said data comprises calibration data for said three-dimensional modeler.

56. The apparatus of claim 42, further comprising a global server configured to:
receive from a requester an order for one or more three-dimensional modeler supplies, said order received via a network interface;
check an inventory of three-dimensional modeler supplies for said one or more three-dimensional modeler supplies;
process payment for said order if said one or more three-dimensional modeler supplies are in said inventory; and
fulfill said order.

57. The apparatus of claim 56 wherein said fulfilling said order comprises sending said one or more three-dimensional modeler supplies to said requestor.

58. The apparatus of claim 56 wherein said fulfilling said order comprises instructing an agent to send said one or more three-dimensional modeler supplies to said requestor.

59. The apparatus of claim 57 wherein said requestor comprises a three-dimensional modeler.

60. An apparatus comprising a client computer configured to:
receive from a user a command to create a build, said build comprising information for use in generating a physical representation of a three-dimensional model;
create said build; and
submit said build to a three-dimensional modeler in a network using a web server integrated with said three-dimensional modeler.

61. The apparatus of claim 60 wherein said client computer is further configured to preview said build before said submitting.

62. The apparatus of claim 60 wherein said client computer is further configured to set one or more parameters of said build before said submitting.

63. The apparatus of claim 60 wherein said client computer is further configured to confirm said build should be submitted to said three-dimensional modeler before said submitting.

64. The apparatus of claim 60 wherein said client computer is further configured to modify a location of one or more builds in a build queue.

65. The apparatus of claim 60 wherein said client computer is further configured to alter one or more details of one or more builds in a build queue.

66. The apparatus of claim 60 wherein said client computer is further configured to change one or more security settings.

67. The apparatus of claim 60 wherein said client computer is further configured to check one or more diagnostics.

68. The apparatus of claim 67 wherein said one or more diagnostics comprises information about a build.

69. The apparatus of claim 67 wherein said one or more diagnostics comprises information about a three-dimensional modeler.

70. An apparatus comprising a three-dimensional modeler configured to:
connect said three-dimensional modeler to a network via a web server integrated with said three-dimensional modeler;
receive a build via said web server, said build comprising information for use in generating a physical representation of a three-dimensional model;
place said build in a queue comprising one or more builds awaiting processing; and
instruct hardware of said modeler to create said physical representation.

71. The apparatus of claim 70 wherein said three-dimensional modeler is further configured to removing said build from said queue.

72. The apparatus of claim 70 wherein said three-dimensional modeler is further configured to reposition said build in said queue.

73. The apparatus of claim 70 wherein said three-dimensional modeler is further configured to combine two or more builds in said queue.

74. The apparatus of claim 70 wherein said three-dimensional modeler is further configured to send one or more diagnostics for said build via said web server.

75. An apparatus comprising a tech support computer configured to:
receive diagnostics of a three-dimensional modeler from a global server configured to establish a session between said global server and said modeler, said modeler coupled to a network via a first firewall, said global server coupled to said network via a second firewall, said three-dimensional modeler for generating a physical representation of a three-dimensional model, said diagnostics comprising information about a build, said build comprising information for use in said generating;
analyze said diagnostics; and
send feedback via said global server, said feedback based at least in part on said analyzing.

76. The apparatus of claim 75 wherein said tech support computer is further configured to send said feedback to one or more client computers.

77. The apparatus of claim 75 wherein said tech support computer is further configured to send said feedback to said three-dimensional modeler.

78. The apparatus of claim 75 wherein said feedback comprises calibration data for said three-dimensional modeler.

79. An apparatus comprising a global server configured to:
receive diagnostics from a three-dimensional modeler via a network interface, said three-dimensional modeler for generating a physical representation of a three-dimensional model, said diagnostics comprising information about a build, said build comprising information for use in said generating;
analyze said diagnostics; and
send feedback via said network interface, said feedback based at least in part on said analyzing.

80. The apparatus of claim 79 wherein said global server is further configured to send said feedback to one or more client computers.

81. The apparatus of claim 79 wherein said global server is further configured to send said feedback to said three-dimensional modeler.

82. The apparatus of claim 80 wherein said feedback comprises calibration data for said three-dimensional modeler.
